(19) United States
(12) Patent Application Publication
(10) Pub. No.: US 2015/0019992 A1
(43) Pub. Date: Jan. 15, 2015

(54) DIGITAL CLOSET

(71) Applicants: Fevi Yu, Georgetown (KY); Susana Vega, Manassas, VA (US)

(72) Inventors: Fevi Yu, Georgetown (KY); Susana Vega, Manassas, VA (US)

(21) Appl. No.: 14/180,650

(22) Filed: Feb. 14, 2014

Related U.S. Application Data
(60) Provisional application No. 61/844,457, filed on Jul. 10, 2013.

(51) Int. Cl. G06F 3/0484

(52) U.S. Cl. CPC G06F 3/04842
USPC 715/747

(57) ABSTRACT

A system and method allows a user to put together an ensemble from a digital closet that represents all the clothes a user owns or could borrow from a friend or family member or purchase from a retailer. Information of the wardrobe items in the users closet are combined with information about the user and the user can direct the particular wardrobe items worn and solicit advise from friends and family via a social network about the ensemble.

### BACKGROUND

1. Technical Field

Embodiments of the present invention relate generally to a system and method of providing a user a virtual wardrobe and, more particularly, to a system that virtualizes a user's wardrobe, other user's wardrobe and potential wardrobe from designers and retailers, allowing the user to receive advice and input on a clothing ensemble from a group of other users.

2. Description of Related Art

Keeping and organizing clothing, especially for those with a large wardrobe is especially daunting. Knowing what the individual owns, or has borrowed, is normally accomplished through memory and cognition. However, where the wardrobe is especially large, one cannot always recall where a particular garment, accessory or other item is stored.

The individual having decided to wear a particular ensemble of items and not recalling directly where the item or items are located, must spend time rummaging through closets, dressers, storage or calling friends to ask if them had borrowed the item. Upon finding the item, they must ascertain whether the item combined with other items of an ensemble achieves the particular presentation the individual is looking for.

The user may solicit friends or family to view them wearing the ensemble and request there input. If neither family nor friends are present, the individual must wait either for them to come home, or, the individual may spend the time drive to their friend's house where they try on the outfit and solicit the friend's advice there.

The solicited advice may be negative and the individual must start the process all over again. Moreover, the solicited advice may only be negative as to a particular item in an ensemble. The item may not look right in relation to the other items of the ensemble or may no longer fit correctly to shrinkage or weight gain.

Where an item does not match the other items of the ensemble or no longer fits, the individual may need to replace it with another item in their wardrobe, a friend's wardrobe or purchase a replacement item. As discussed above, when the user needs an item they must recall its location or rummage around until found then re-solicit input from others and perhaps travel to receive input.

When the item does not fit and a new purchase is required, the individual must travel to a brick and mortar establishment or order the item online. If ordering online, the individual does not have the opportunity to try the item on. As the sizing between designers and retailers vary, the individual ordering an item online is left wondering whether the product eventually delivered will fit.

The aforementioned and other shortcomings are illustrative rather than exhaustive. Conventional approaches my have yet other drawbacks.

### BRIEF SUMMARY

An aspect of the present invention provides a computerized digital closet system, the system includes a storage component that stores user information and closet information of each of a plurality of users, the closet information defining individual items of a wardrobe, the user information defining characteristics of the user. The system also includes a ensembling component configured to define a relationship between user information of the user and the closet information of the user retrieved from the storage component and input from users. The system also includes a display component configured to (i) display the defined relationship between the user information and the closet information on a device of the user, and (ii) receive input from the user, the input defining a change to the relationship between the user information and the closet information, the change to the relationship between the user information and the closet information forwarded to the ensembling component.

Another aspect of the present invention provides a method of arranging a wardrobe, the method includes retrieving from a storage, user information and closet information of each of a plurality of users, the closet information defining individual items of a wardrobe, the user information defining characteristics of the user. Then, defining a relationship between user information of the user and the closet information of the user retrieved from the storage and input from users. Displaying the defined relationship between the user information and the closet information on a device of the user. Then, receiving input via the device of the user, input defining a change to the relationship between the user information and the closet information.

Another aspect of the present invention provides a computer readable storage medium executing the method summarized above.

This Summary is provided to introduce a selection of concepts in a simplified form that are further described below in the Detailed Description. This Summary is neither intended to identify key features or essential features of the claimed subject matter, nor should it be used to limit the scope of the claimed subject matter. Furthermore, the claimed subject matter is not limited to implementations that solve any disadvantage noted in any part of this application.

The aforementioned and/or other features, aspects, details, utilities, and advantages of the present invention are: set forth in the detailed description which follows and/or illustrated in the accompanying drawings; possibly inferable from the detailed description and/or illustrated in the accompanying drawings; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1. is a system diagram of an embodiment of the present invention;

FIG. 2. is a system diagram of information stored by the present invention and associations made between the information;

FIG. 3. is a table defining the data stored for wardrobe items as part of closet information of the present invention;

FIG. 4. is a table defining the data stored about a user information of the present invention;

FIG. 5. is a rendering of a user interface of the present invention;

FIG. 6. is a rendering of a user interface of the present invention;

FIG. 7. is a diagram illustrating the types of wardrobe items that can be combined by a user of the present invention;

FIG. 8 is a network diagram of the flow of data between components of the instant invention;

FIG. 9 is a flow chart of a method of execution of the instant invention; and

FIG. 10 is a schematic diagram of a processing system executing the components of instant invention.

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

Although the following text sets forth a detailed description of at least one embodiment or implementation, it is to be understood that the legal scope of protection of this application is defined by the words of the claims set forth at the end of this disclosure. The detailed description is to be construed as exemplary only and does not describe every possible embodiment since describing every possible embodiment would be impractical, if not impossible. Numerous alternative embodiments and/or implementations are both contemplated and possible, using either current technology or technology developed after the filing date of this patent, which would still fall within the scope of the claims

It is to be understood that, unless a term is expressly defined in this application using the sentence “As used herein, the term” is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

The present invention allows a user to put together an ensemble from a digital closet that represents all the clothes a user owns or could borrow from a friend or family member or purchase from a retailer. Information of the wardrobe items in the users closet are combined with information about the user and the user can direct the particular wardrobe items worn and solicit advise from friends and family via a social network about a digital representation of the user wearing the ensemble.

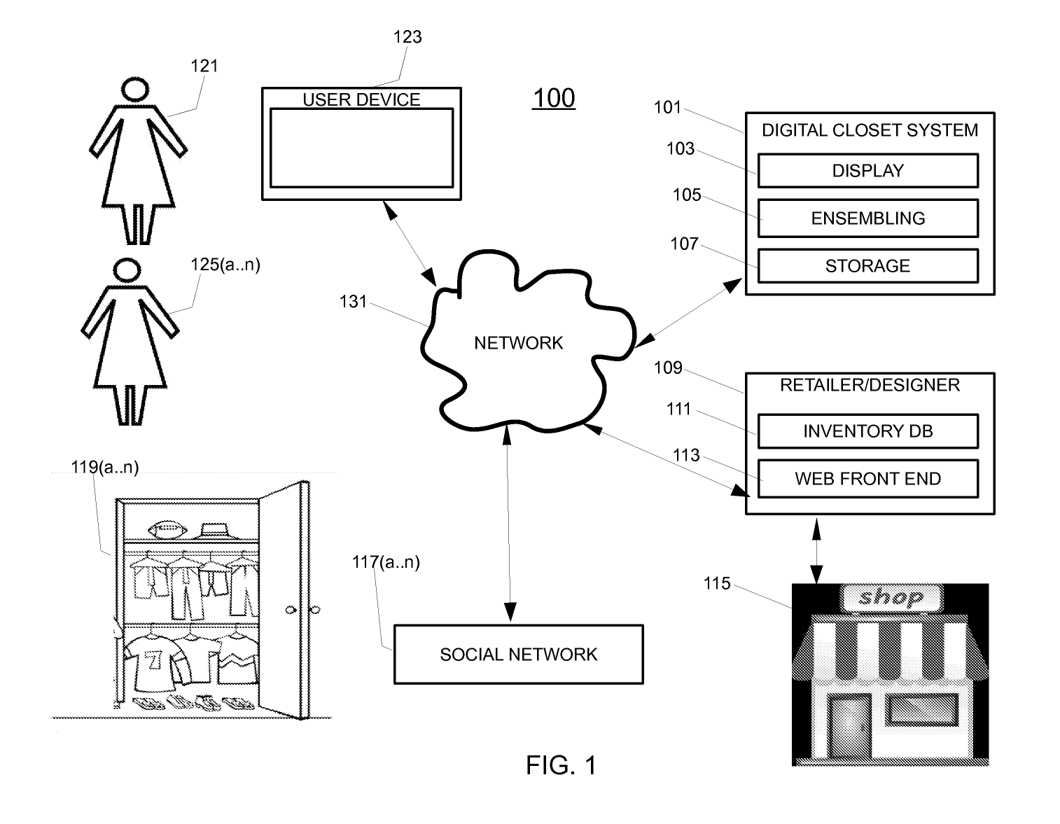

Referring now to FIG. 1, a system 100 for providing a user 121 with digital ensembles from his or her wardrobe is illustrated. The system 100 includes a digital closet system 101. The digital closet system 101 includes a storage component that stores closet information and user information; an ensembling component 105 for defining a relationship between items of closet information and user information stored by the storage component; and a display component 107 for displaying on the user device 123 the defined relationship between the closet information and user information.

The system 100 further includes retailer/designer system 109 for allowing the viewing and purchasing of wardrobe items. The retailer/designer system 109 stores information about wardrobe items and purchase, history, etc. . . . , that includes an inventory database 111 and a web front end 113 for allowing access to the inventory database 111 and other functionality of a web-based merchant.

The web-based merchant implementing a retailer/designer system 109 may have a brick and mortar shop 115 where a user 121 can enter and browse in person for items to be integrated into his or her wardrobe. While at the brick and mortar shop 115 the user can use an end-user device similar to user device 123, to integrate an item found in the brick and mortar shop 115 to other items in the user's wardrobe.

The system 100 further includes social networking sites 117(a . . . n), for providing relationships between user 121 and friends and family 125(a . . . n). The social networking sites 117(a . . . n) may also provide user validation and linking and transfer protocols for the electronic components of the system 100. Social networking sites 117(a . . . n) could include, for example, Facebook™, Google+™, MySpace™, Pinterest™, etc. . . . .

Each of the electronic components: digital closet system 100, retailer/designer 109, social network 117(a . . . n) and user device 123 are connected to each other via a network 131 such as the internet or other networks that are known in the art.

The user 121 and friends and family and friends 125(a . . . n), each have a physical items stored in at least one physical closet or wardrobe 119(a . . . n). The wardrobe items of the physical closet or wardrobe 119(a . . . n) are cataloged and stored as closet information in the storage component 107 of the digital closet system 101.

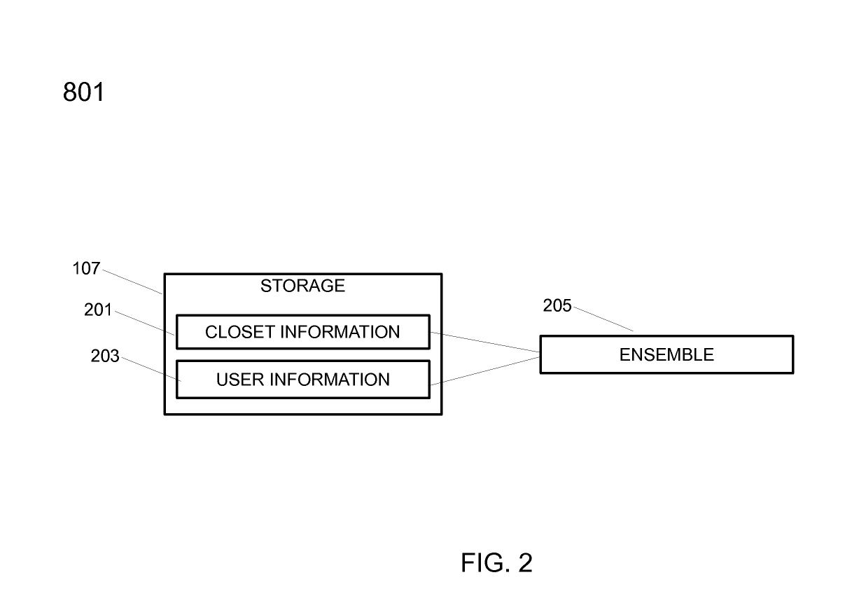

Referring now to FIGS. 2-4, FIG. 2 illustrates the contents of the storage 107 which includes both closet information 201 and user information 203. The combination of the closet information 201 and user information 203 defines the ensemble 205 a user 121 will or can wear.

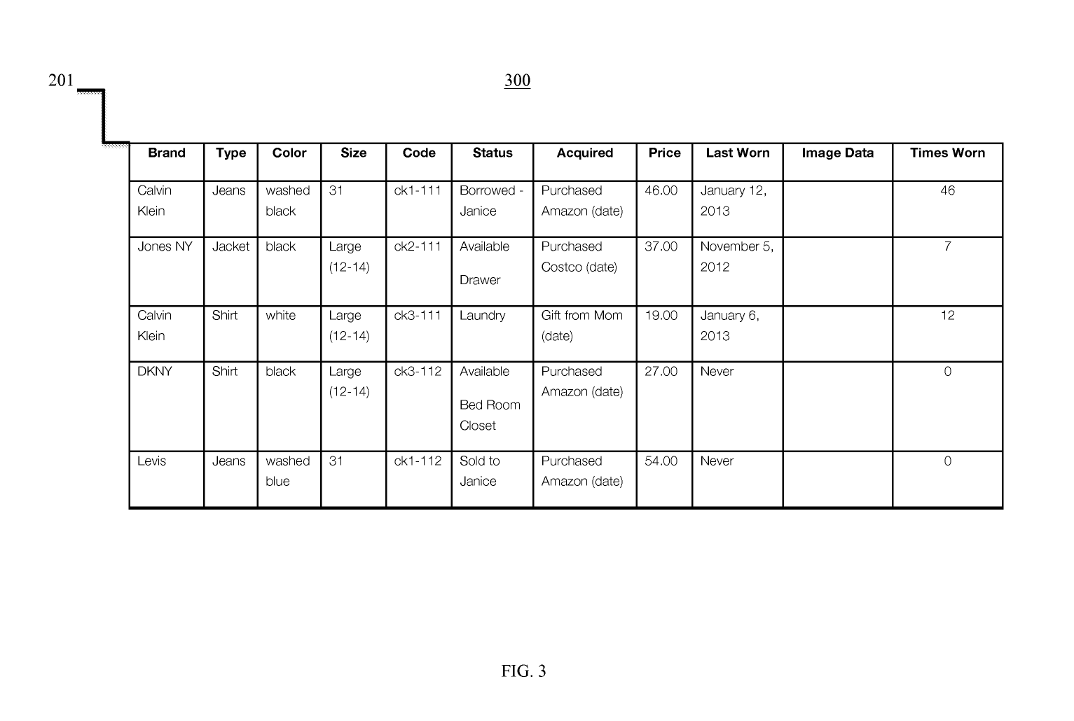

FIG. 3 illustrates the contents of the closet information 201 as a table 300. The table 300 includes a series of rows where each row defines a separate item of the user 121's wardrobe. Each column of the table 300 defines a separate type of datum. The first column of the table 300 defines the brand name of the wardrobe item. The second column of the table 300 defines the type of wardrobe item, the type defining the function. For example, jeans are pants used to cover the lower torso and legs of the user 121, whereas a jacket covers the upper portion of the user optionally over a shirt, which may cover the same areas of the user 121's body. It will be understood that each wardrobe item has a separate function and covers a separate portion of the user 121's body.

The third column of the table 300 defines the color of wardrobe item. The fourth column of the table 300 defines the size of the wardrobe items. It will be understood that the size of an item will differ from brand to brand. In other words, size 10 dresses, may fit user 121 perfectly when the designer is Ralph Lauren™, but user 121 may require a size 14 from Jones New York™.

The fifth column of the table 300 defines a code that uniquely defines the item of the wardrobe.

The sixth column of the table 300 defines the status of the wardrobe item. The status column indicates whether the wardrobe item is available for the user 121 to wear. The status column may also indicate whether the user 121 let a friend or family member borrow the wardrobe item or the user 121 has borrowed the item from a friend or family member 127(a . . . n). The status also includes the location of the wardrobe item. For example, the location could be in a closet, in a drawer, on a shelf, at the dry-cleaners, in the laundry, in storage to name just a few.

The seventh column of the table 300 defines the how the wardrobe item was acquired. For example, direct purchase at a brick and mortar store, purchase online, or as a gift. The eighth column of the table 300 defines the price paid for the item if known. The ninth column of the table 300 defines the last time the user 121 wore the item. The tenth column contains image data for the piece of clothing. The eleventh column of the table 300 defines the number of times a wardrobe item has been worn by the user 121.

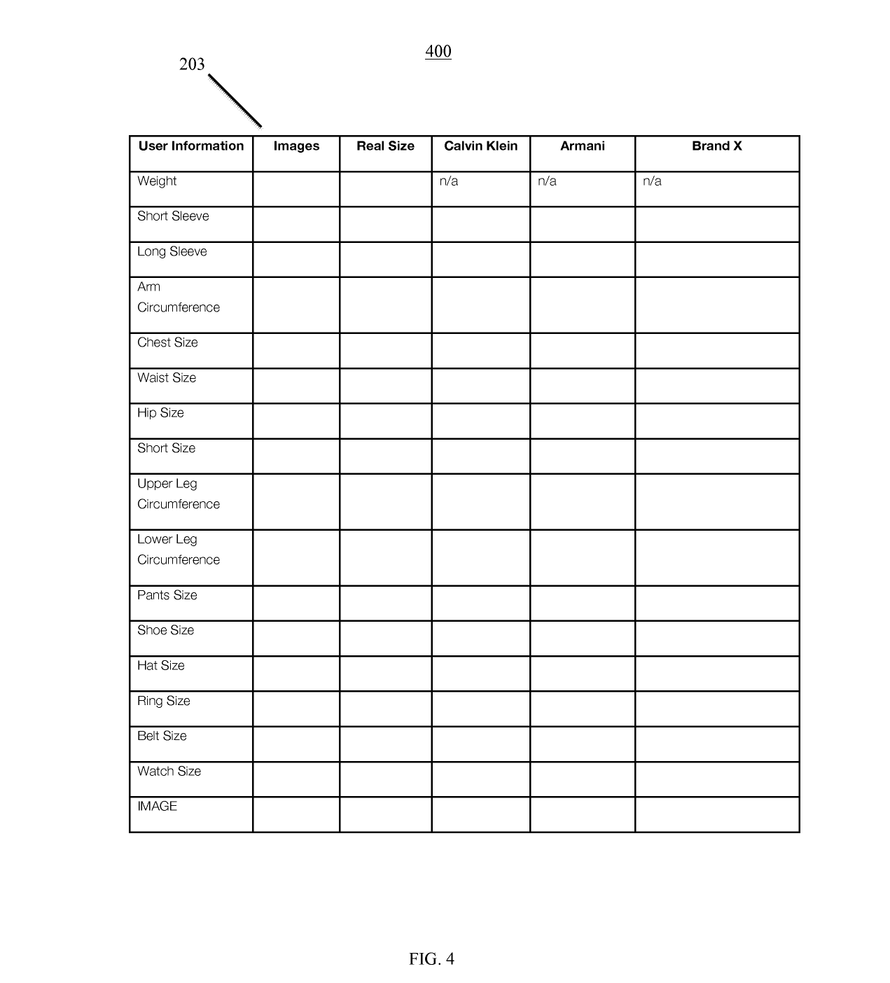

FIG. 4 illustrates a table 400 that forms the basis for the user information 203. The table 400 includes a series of columns that define various measurements of the user 121's body. These measurements may be defined as a length, height, width, weight or a size where appropriate. The table 400 includes a series of rows, where the first column of the table 400 defines which portion of a user 121's body is measured. Each row of the first column of the table 400 defines where a measurement is taken or for what a measurement is taken. The second column of the table 400 include image data of the user 121 for the particular body part or the body as a whole. The image is used in rendering an image of the user 121 wearing an ensemble.

The third column of the table 400 defines the actual measurement. Each of the remaining columns of the table 400 defines brands that the user 121 has used in the past or will use in the future. Each of columns three on of the table 400 defines the corresponding size for each measurement. For example, a pair of pants made by Calvin Klein™, has a 27 inch waist and fit user 121 perfectly. However, user 121 requires a pair with a 28 inch waist when the jeans are made by Armani™. Thus, the size for each brand may differ from the size of the user 121.

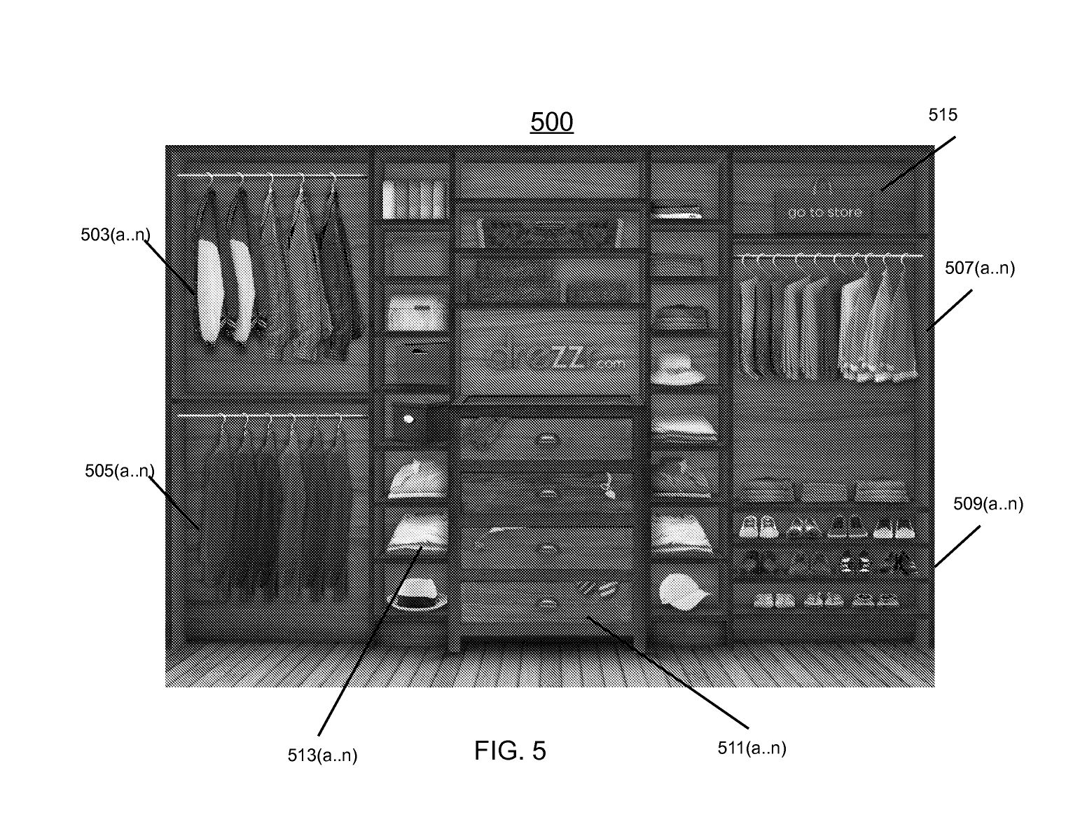

Referring now to FIG. 5, a user interface 500 of an embodiment of the present invention is illustrated. The user interface 500 illustrates a rendering of a wardrobe of the user 121. The wardrobe includes the wardrobe items 503(a . . . n), 505(a . . . n), 507(a . . . n), 509(a . . . n), 511(a . . . n) and 513(a . . . n). Each of the wardrobe items 503(a . . . n), 505(a . . . n), 507(a . . . n), 509(a . . . n), 511(a . . . n) and 513(a . . . n) represent an actual wardrobe item that user 121 owns. It will be understood, that while the representation of the actual items are rendered in a single wardrobe 500, they in reality may be at different locations as defined in table 300. The actual location may be revealed by floating a pointer over the item or clicking on the item to display more detailed information about the item as found in table 300

Additionally, wardrobe items 511(a . . . n) are held, for example, in drawers and the drawers can be opened by clicking on them and the wardrobe items 511(a . . . n) rendered on the display 500. The same is true for wardrobes items 513(a . . . n) on the shelves of the rendered wardrobe 500.

Additionally, beyond the wardrobe items 503(a . . . n), 505(a . . . n), 507(a . . . n), 509(a . . . n), 511(a . . . n) and 513(a . . . n) the user may purchase a further wardrobe item by clicking on the “go to store” button 515.

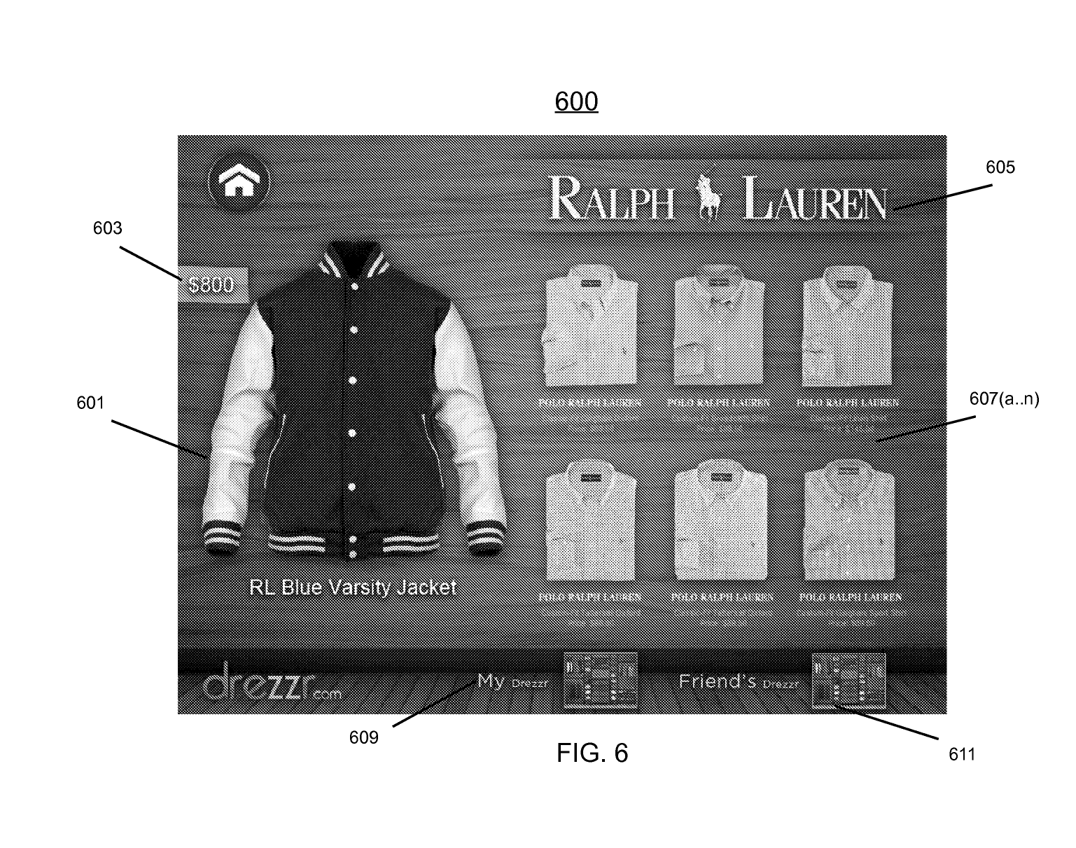

Referring now to FIG. 6, a user interface 600 of an embodiment of the present invention is illustrated. A user having determined they require an additional wardrobe item is directed to a purchase page interface 600. The interface 600 is either provided by the designers and retailers 605 of wardrobe items, or via an interface the instant invention. The user 121 has chosen a new jacket 601 with a purchase price 603. In addition to the jacket 601, the user can also choose other wardrobe items 607(a . . . n). After the user 121 has chosen the jacket 601 he or she can purchase the jacket 601 an manner well know in the art. As part of the purchase process, the user 121 may make a gift of the jacket 601 by dropping it into a friend or family's wardrobe 611. However, if the user 121 were purchasing the item then her or she would drop the item in user 121's wardrobe 609.

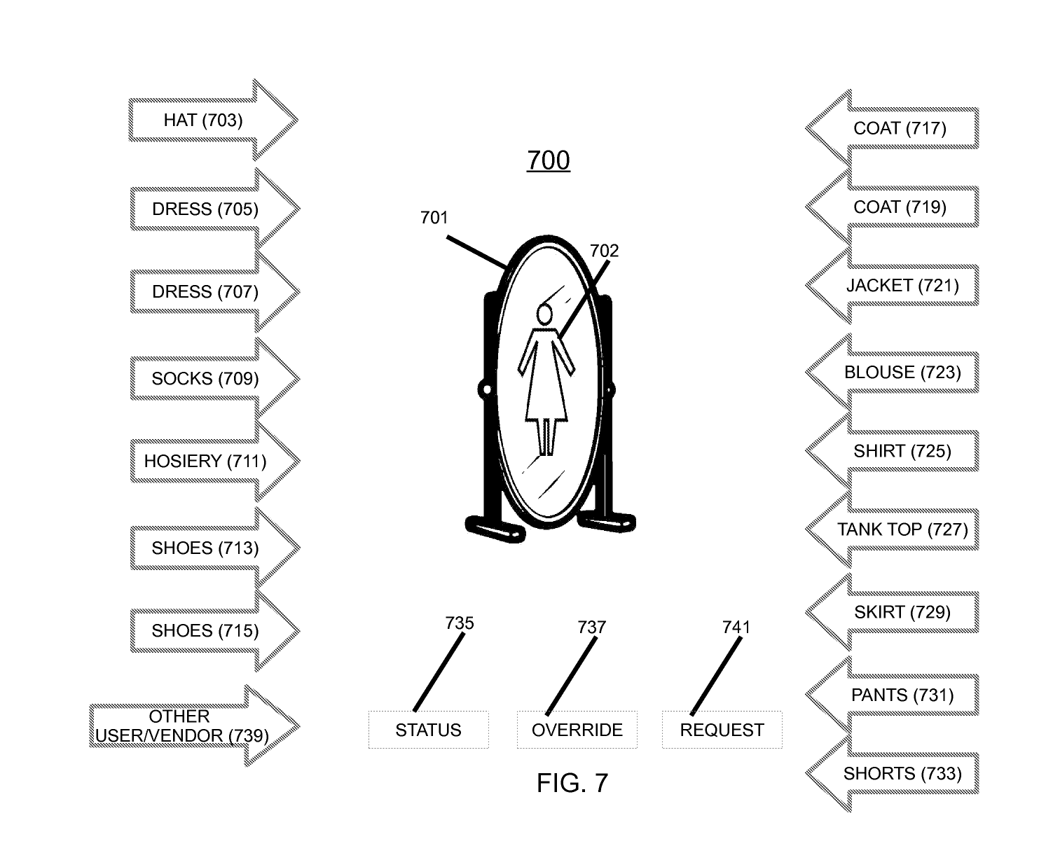

Referring now to FIG. 7, a user interface 700 of an embodiment of the present invention is illustrated. The user 121 having logged into digital closet system 100 is presented on his or her display a rendering of their wardrobe in interface 500. The user may then drag any number of wardrobe items to a virtual mirror displaying an image of user 121.

The user 121 initially believes that she is going to a formal occasion and drags the dress 705 onto the mirror. The display component 103 receives the drag and drop of the dress 705 onto the mirror 701 via the user device 123. The display component 103 forwards the information of the change in wardrobe item to the ensembling component 105. The ensembling component 105 understands the function or type of wardrobe item (i.e. dress 705) as defined in the table 300 and therefore can define the dress 705's function to other characteristics of the user 121 as defined in the table 400.

For example, the user 121's characteristics as defined in table 400 could have gained twenty pounds since the last time the dress 705 has been worn. The defined relationship between the closet information 201 and the user information 203 does not allow the dress to be worn by the user 121. This information is forwarded back to the display component 103 where status information 735 that the “dress 705 does not fit” is displayed.

The user 121 may override 737 such an indication 735 and the ensembling component 105 will define the association between closet information 201 and the user information 203 from the tables 300 and 400 and forward the information to the display component 103 which will render an image 702 of the user 121 wearing the dress on the mirror 701.

The user 121 seeing the rendered image of the ill fitting dress 705 then chooses dress 707 and drags and drops the dress onto the mirror 701. The display component 103 forwards this information to the ensembling component 105. The ensembling component 105 understands from the closet information 201 that the dress 705 and 707 have the same function and then removes the dress 705 from the ensemble that comprises all the total wardrobe defined by an association between closet information 201 and the user information 203. The ensembling component 105 checks other closet information 201 as defined in the table 300 against the user information 203 as defined in table 400 and if all the comparisons are positive then the ensemble is defined as association between the closet information 201 and the user information 203 is forwarded to the display component 103 which renders the user 121 wearing the dress 707 in the mirror 702.

The user 121 may also wish to wear hat 703, hosiery 711 and shoes 713. When each of these items is dragged and dropped into the mirror 701, the display component 103 forwards the changes to the ensembling component 105. The ensembling component 105 checks the functions of each of the hat 703, hosiery 711 and shoes 713 and finds that they do not conflict with each other. Further, the ensembling component understands the function of each item in the ensemble. For example, that hosiery 711 is layered below the dress 707 and shoes 713, but above the image of user 121's legs in an image of the user stored in the user information 203. The when the defined association between the closet information 201 and the user information 203 is forwarded to the display component 103, the image 702 is properly rendered with each wardrobe item of the ensemble in the proper place with regards to the image of the user 121.

The user 121 may also need to wear a coat, as it is wintertime. The user 121 can drag coat 717 to the mirror 701. The display component 103 forwards the changes to the ensembling component 105. The ensembling component 105 checks the functions of the coat 717 against the function of the dress 707, hat 703, hosiery 711 and shoes 713. As the functions of none of the wardrobe items of the ensemble 205 are in conflict with the function of the coat 717, the coat 717 is added to the ensemble 205. The defined association of the closet information 201 and the user information 203 is forwarded to the display component 103 which displays the ensemble 205 as the image 702 with the coat 717 rendered above the dress 707.

A user 121 may also wish to wear a more casual outfit. As such an ensemble 205 may consist of a blouse 723, socks 709 and shoes 715 and a skirt 729. When each of these items is dragged to the mirror 701, the function of each is checked again each other and user characteristics in the user information 203 as embodied in the table 400. When performing the check, it is determined that the blouse 723 is at the “laundry” and therefore, not available to wear. The ensembling component 105 forwards to the display component status information 735 indicating that the blouse 723 is at the laundry. The ensembling component 105 can either wait for the user 121 to enter a further wardrobe item with the same function or search the storage 107 for other wardrobe items in the closet information 201 of the table 300. The ensembling component 105 locates the shirt 725 as having the same function as blouse 723, adds it to the ensemble 205 and presents it to the display component 103 for rendering in the image 702.

It will be understood that the user 121 can hit the override button 737 as she plans to pickup the blouse 723 from the laundry that day. In which case, the ensembling component 105 adds the blouse 723 to the ensemble 205. The ensembling component 105 then forwards the defined relationship between the closet information 201 and the user information 203 that embodies the ensemble 205 to the display component 103 where it is rendered as the image 702.

It will be understood that the user 121 may also add either a coat 719 or jacket 721 to the ensemble. It will be further understood, where the jacket 721 is a light jacket, it may be layered under the coat 719 when the type of wardrobe item in table 300 indicates a layer may be word above it. For example, a men's winter over coat may be layered above a suit jacket. In essence the function or type as defined in table 400 is different. Likewise, a tank-top 727, could be layered under the blouse 723 or the shirt 725, as while they have similar functions are understood to allow layering.

The pants 731 or shorts 733 may be drag and dropped to the mirror 701. As the functions of each of these items is in conflict with that of the skirt 729, the ensembling component 105 will remove the skirt 729 and replace it with either the pants 731 or shorts 733.

The user 121 having not found an ensemble 205 that meets his or her needs can receive additional wardrobe items from (family or friends 127(a . . . n) or retailers/designers 739. The user 121 can solicit or request 741 advice from another user 127(a . . . n). The requested advice can allow the other user (i.e. friends and family 127(a . . . n)) through the conduit of a social network 117(a . . . n) to view the image 702. The other user (i.e. friends and family 127(a . . . n)) can drag and drop wardrobe items 503(a . . . n), 505(a . . . n), 507(a . . . n), 509(a . . . n), 511(a . . . n) and 513(a . . . n) from user 121's wardrobe 500 to the mirror 701 or drag and drop items from his or her virtual wardrobe 611 to the mirror for user 121's viewing and borrowing of an item.

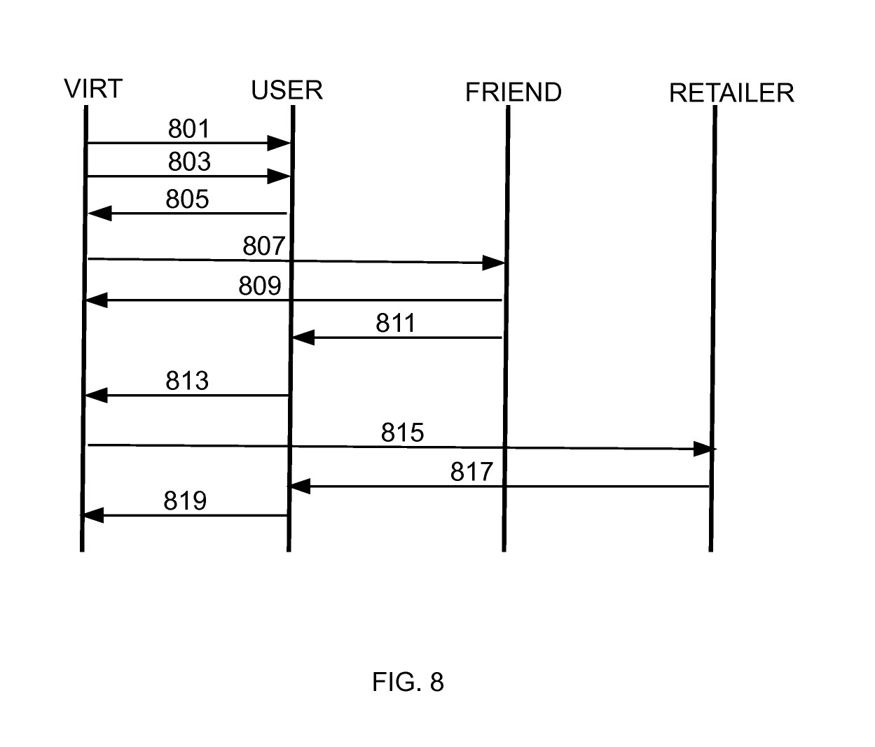

Referring now to FIG. 8, a network diagram showing the flow of wardrobe items is illustrated. The ensembling component 105 is tasked with defining the relationship between closet information 201 and user information 203. Additionally the system 101 can receive initial information via the display component of wardrobe items in a user's physical wardrobe 119(a . . . n). The user 121 enters this information and it is transmits (801) the closet information 201 to storage 107 for the user 121.

The user 121 in using embodiments of the present invention can have the ensembling component 105 request (803) closet information 201 from the storage 107 belonging to the user 121. The requested closet information 201 is transmitted (805) back to ensembling component 105 where it is combined with other wardrobe items and displayed the user 121.

The user 121 in using embodiments of the present invention can have the ensembling component 105 request (807) a friend 125(a . . . n) give input of a ensemble 205 the user has put together. The friend 125(a . . . n) has advice about the ensemble 205 transmitted (809) back to the ensembling component 105. In response to request (807) the friend 125(a . . . n) can also allow the user 121 to borrow a wardrobe and forward (811) that wardrobe item to be stored in the storage 107 for the user 121. The borrowed wardrobe item is then transmitted (813) to the ensembling component 105.

The user 121 may also request (815) to purchase a new item from a retailer or designer 109. Upon purchase of a new wardrobe item, information about the new wardrobe item is transmitted (817) to the storage 107 for the user 121. The new wardrobe item is then transmitted (819) from the storage 107 for the user 121 to the ensembling component 105.

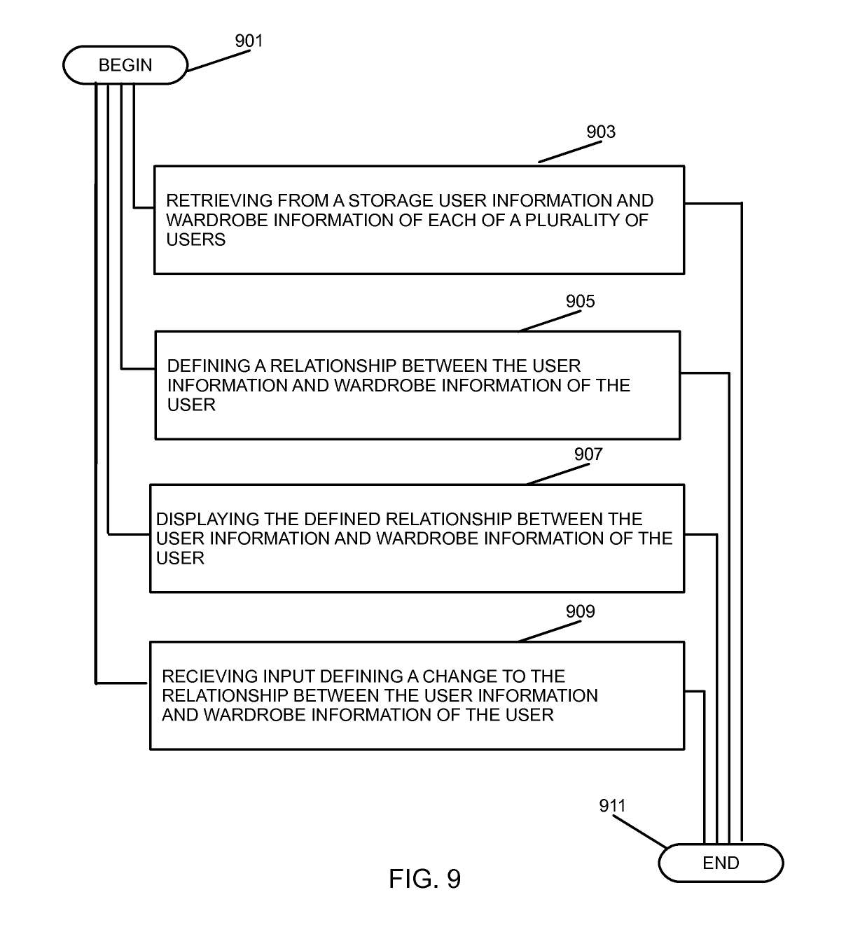

Referring now to FIG. 9, a flowchart illustrating the steps of a method of an embodiment of the instant invention. The user 121 begins execution (901) by logging into the digital closet system 101. It is understood from previous disclosure herein, that the user connects via a user device 123 of his or her own, the user device 123 of a friend 125(a . . . n), or the user device at a brick and mortar shop 115.

The digital closet system then retrieves (903) from a storage 107 user information 201 and closet information 203 of each of a plurality of users 121 and 125(a . . . n), the closet information 201 defining individual items of a wardrobe 300, the user information 203 defining characteristics 400 of the user 121.

Next, the ensembling component 105 of the digital closet system 101 defines (905) a relationship 205 between the user information 203 of the user 121 and the closet information 201 of the user 121 retrieved from the storage 107 and input from users 121 and 123(a . . . n).

With a defined relationship 205 established, the display component displays (907) the defined relationship 205 and change to the relationship between the user information 203 and the closet information 201 on a device 123 of the user 121.

The user 121 may also alter the defined relationship 205 by entering input, via the device 123 of the user 121, defining a change to the relationship between the user information 203 and the closet information 201.

It will be understood that the steps of the invention may executed in the sequence disclosed above, or any combination of steps.

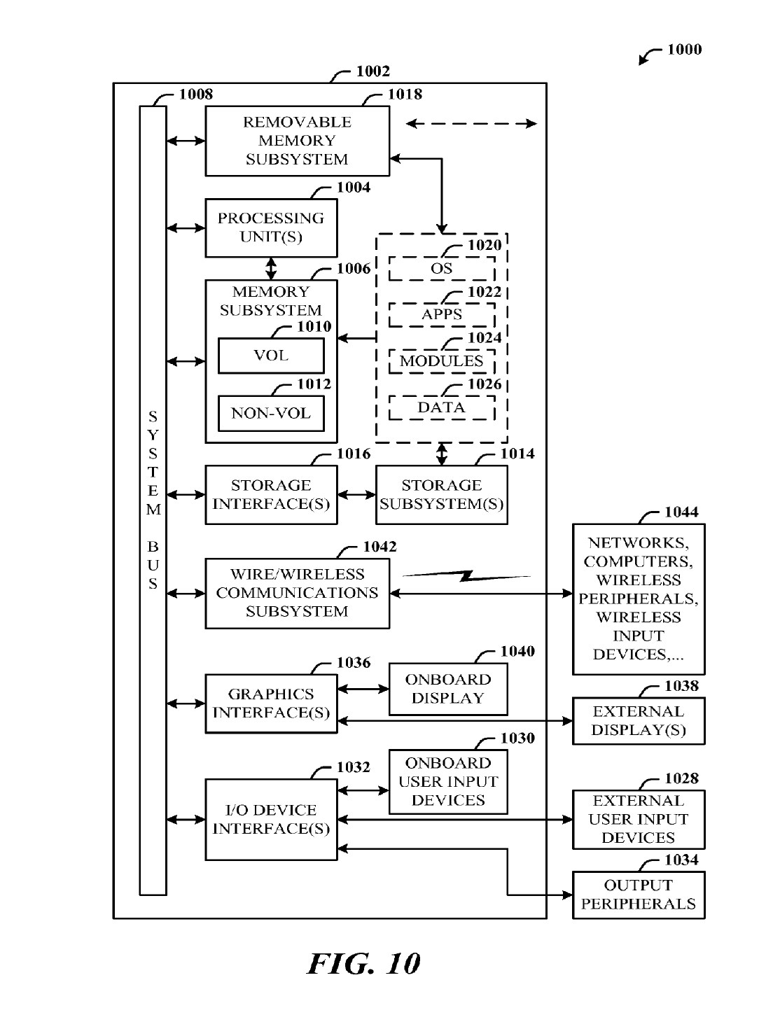

Referring now to FIG. 10, there is illustrated a block diagram of a computing system 1000 that executes relevant information promotion in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 10 and the following description are intended to provide a brief, general description of the suitable computing system 1000 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1000 for implementing various aspects includes the computer 1002 having processing unit(s) 1004, a computer-readable storage such as a system memory 1006, and a system bus 1008. The processing unit(s) 1004 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1006 can include computer-readable storage (physical storage media) such as a volatile (VOL) memory 1010 (e.g., random access memory (RAM)) and non-volatile memory (NON-VOL) 1012 (e.g., ROM, EPROM, EEPROM, etc.). A basic input/output system (BIOS) can be stored in the non-volatile memory 1012, and includes the basic routines that facilitate the communication of data and signals between components within the computer 1002, such as during startup. The volatile memory 1010 can also include a high-speed RAM such as static RAM for caching data.

The system bus 1008 provides an interface for system components including, but not limited to, the system memory 1006 to the processing unit(s) 1004. The system bus 1008 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1002 further includes machine readable storage subsystem(s) 1014 and storage interface(s) 1016 for interfacing the storage subsystem(s) 1014 to the system bus 1008 and other desired computer components. The storage subsystem(s) 1014 (physical storage media) can include one or more of a hard disk drive (HDD), a magnetic floppy disk drive (FDD), and/or optical disk storage drive (e.g., a CD-ROM drive DVD drive), for example. The storage interface(s) 1016 can include interface technologies such as EIDE, ATA, SATA, and IEEE 1394, for example.

One or more programs and data can be stored in the memory subsystem 1006, a machine readable and removable memory subsystem 1018 (e.g., flash drive form factor technology), and/or the storage subsystem(s) 1014 (e.g., optical, magnetic, solid state), including an operating system 1020, one or more application programs 1022, other program modules 1024, and program data 1026.

The operating system 1020, one or more application programs 1022, other program modules 1024, and/or program data 1026 can include entities and components of the system 100 of FIG. 1 and the methods represented by the flowcharts of FIGS. 4-7, for example.

Note that although described in the context of a computer, the disclosed architecture is equally applicable to mobile devices have similar computing capabilities individually, or as provided in combination with cloud computing.

Generally, programs include routines, methods, data structures, other software components, etc., that perform particular tasks or implement particular abstract data types. All or portions of the operating system 1020, applications 1022, modules 1024, and/or data 1026 can also be cached in memory such as the volatile memory 1010, for example. It is to be appreciated that the disclosed architecture can be implemented with various commercially available operating systems or combinations of operating systems (e.g., as virtual machines).

The storage subsystem(s) 1014 and memory subsystems (1006 and 1018) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available storage media that can be accessed by the computer 1002 and includes volatile and non-volatile internal and/or external media that is removable or non-removable. For the computer 1002, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture. As the computer media is limited to storage media it will be understood that transitory media, such as a signal, are excluded from the definition of computer readable media.

A user can interact with the computer 1002, programs, and data using external user input devices 1028 such as a keyboard and a mouse. Other external user input devices 1028 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1002, programs, and data using onboard user input devices 1030 such a touchpad, microphone, keyboard, etc., where the computer 1002 is a portable computer, for example. These and other input devices are connected to the processing unit(s) 1004 through input/output (I/O) device interface(s) 1032 via the system bus 1008, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1032 also facilitate the use of output peripherals 1034 such as printers, audio devices, camera devices, and so on, such as a sound card and/or onboard audio processing capability.

One or more graphics interface(s) 1036 (also commonly referred to as a graphics processing unit (GPU)) provide graphics and video signals between the computer 1002 and external display(s) 1038 (e.g., LCD, plasma) and/or onboard displays 1040 (e.g., for portable computer). The graphics interface(s) 1036 can also be manufactured as part of the computer system board.

The computer 1002 can operate in a networked environment (e.g., IP-based) using logical connections via a wired/wireless communications subsystem 1042 to one or more networks and/or other computers. The other computers can include workstations, servers, routers, personal computers, microprocessor-based entertainment appliances, peer devices or other common network nodes, and typically include many or all of the elements described relative to the computer 1002. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1002 connects to the network via a wired/wireless communication subsystem 1042 (e.g., a network interface adapter, onboard transceiver subsystem, etc.) to communicate with wired/wireless networks, wired/wireless printers, wired/wireless input devices 1044, and so on. The computer 1002 can include a modem or other means for establishing communications over the network. In a networked environment, programs and data relative to the computer 1002 can be stored in the remote memory/storage device, as is associated with a distributed system. It will be appreciated that the network connections shown are exemplary and other means of establishing a communications link between the computers can be used.

The computer 1002 is operable to communicate with wired/wireless devices or entities using the radio technologies such as the IEEE 1002.xx family of standards, such as wireless devices operatively disposed in wireless communication (e.g., IEEE 1002.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 1002.11x (a, b, g, etc.) to provide secure, reliable, fast wireless connectivity. A Wi-Fi network can be used to connect computers to each other, to the Internet, and to wire networks (which use IEEE 1002.3-related media and functions).

Examples of various features/aspects/components/operations have been provided to facilitate understanding of the disclosed embodiments of the present invention. In addition, various preferences have been discussed to facilitate understanding of the disclosed embodiments of the present invention. It is to be understood that all examples and preferences disclosed herein are intended to be non-limiting.

Although selected embodiments of the present invention have been shown and described individually, it is to be understood that at least aspects of the described embodiments may be combined.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

We claim:

1. A computerized digital closet system, the system comprising:
a storage component that stores user information and closet information of each of a plurality of users, the closet information defining individual items of a wardrobe, the user information defining characteristics of the user;
an ensembling component configured to define a relationship between user information of the user and the closet information of the user retrieved from the storage component and input from users; and
a display component configured to
(i) display the defined relationship between the user information and the closet information on a device of the user, and
(ii) receive input from the user, the input defining a change to the relationship between the user information and the closet information, the change to the relationship between the user information and the closet information forwarded to the ensembling component.

2. The computerized digital closet system of claim 1, wherein
each item of the defined individual items comprise the item function, size, location and associated image, and
the characteristics of the user comprise a size of the user and an image of the user.

3. The computerized digital closet system of claim 2, wherein the defined relationship between user information of the user and the closet information matches the size of the user to the size of an item.

4. The computerized digital closet system of claim 3, wherein the defined relationship between user information of the user and the closet information is an ensemble, each item in the ensemble having a separate function.

5. The computerized digital closet system of claim 2, wherein the displayed defined relationship between the user information and the closet information is a rendering of the image of the user overlaid with an image of at least one of the individual items of a wardrobe.

6. The computerized digital closet system of claim 1, wherein the display component is configured to receive input of an other user to further define the relationship between the user information and the closet information for the user.

7. The computerized digital closet system of claim 6, wherein the individual items of the other user's closet information are transferred temporarily to the closet information of the user, and
the temporarily transferred individual items of the other user's wardrobe used to change to the relationship between the user information and the closet information.

8. The computerized digital closet system of claim 2, wherein the ensembling component defines the relationship between the user information and the closet information based upon prior usage of the items of a wardrobe with relationship to each other.

9. The computerized digital closet system of claim 1, wherein based the user information, an item of designers and retailers of wardrobe items is temporarily transferred from the designers and retailers of wardrobe items to the closet information of the user, the temporarily transferred item is used to define a relationship between user information of the user and the closet information.

10. The computerized digital closet system of claim 9, the temporarily transferred item is made permanent upon the purchase and receipt of the item from the designers and retailers of wardrobe items.

11. The computerized digital closet system of claim 10, the receipt of an item is determined via electronic shipping information associated with the purchase of the item from the designers and retailers of wardrobe items.

12. The computerized digital closet system of claim 9, wherein the display component displays and receives information on a device located at a physical location of the designers and retailers of wardrobe items.

13. The computerized digital closet system of claim 2, further comprises:
an electronic tag that uniquely identifies the device; and
an electronic tag reader of the tag that forwards the location to the storage component.

14. The computerized digital closet system of claim 2, wherein the location is inputted via the display component.

15. A method of arranging a wardrobe, the method comprising:
retrieving from a storage, via a programmed processor, user information and closet information of each of a plurality of users, the closet information defining individual items of a wardrobe, the user information defining characteristics of the user;
defining a relationship between the user information of the user and the closet information of the user retrieved from the storage and input from users;
displaying the defined relationship and change to the relationship between the user information and the closet information on a device of the user; and
receiving input, via the device of the user, defining a change to the relationship between the user information and the closet information.

16. The method of claim 15, wherein
each item of the defined individual items comprise the item function, size, location and associated image, and
the characteristics of the user comprise a size of the user and an image of the user.

17. The method of claim 16, wherein the defined relationship between user information of the user and the closet information matches the size of the user to the size of an item.

18. The method of claim 17, wherein the defined relationship between user information of the user and the closet information is an ensemble, each item in the ensemble having a separate function.

19. The method of claim 16, wherein the displayed defined relationship between the user information and the closet information is a rendering of the image of the user overlaid with an image of at least one of the individual items of a wardrobe.

20. A computer readable storage medium with a computer program stored thereon, the computer program executed by a processor to perform a method of arranging a wardrobe, the method comprising:
retrieving from a storage, via a programmed processor, user information and closet information of each of a plurality of users, the closet information defining individual items of a wardrobe, the user information defining characteristics of the user;
defining a relationship between user information of the user and the closet information of the user retrieved from the storage and input from users;
displaying the defined relationship and change to the relationship between the user information and the closet information on a device of the user; and
receiving input via the device of the user, defining a change to the relationship between the user information and the closet information.
